(19) United States
(12) Patent Application Publication
(10) Pub. No.: US 2009/0232568 A1
(43) Pub. Date: Sep. 17, 2009

(54) FIXING APPARATUS AND DEVELOPER FIXING METHOD FOR THE FIXING APPARATUS

(75) Inventor: Masaya Tanaka, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/400,037

(22) Filed: Mar. 9, 2009

Related U.S. Application Data
(60) Provisional application No. 61/037,044, filed on Mar. 17, 2008.

(51) Int. Cl. G03G 15/20

(52) U.S. Cl. 399/329; 399/333

(57) ABSTRACT

A fixing apparatus includes: a pressing roller having a heating device therein; a metal roller having a core bar of metal; and a fixing roller that is set in contact with the pressing roller across a fixing belt wound around the fixing roller and the metal roller, has the width of the center portion formed in a cylindrical shape smaller than the width of the pressing roller, and has, at both ends, small-diameter rollers having a diameter smaller than the diameter of the center portion. Since stress is not applied to both ends of the fixing belt, the durable life of the fixing belt is extended.

### CROSS-REFERENCE TO RELATED APPLICATION

This application is based upon and claims the benefit of priority from the prior U.S. Patent Application No. 61/037,044, filed on 17 Mar. 2008, the entire contents of which are incorporated herein by reference.

### TECHNICAL FIELD

The present invention relates to image forming apparatuses such as a copying machine and a printer, and, more particularly to an image forming apparatus with improved durable life of a belt of a belt fixing apparatus, which fixes a developer, and a developer fixing method for the image forming apparatus.

### BACKGROUND

An image forming apparatus includes a fixing apparatus that heats and presses a developer such as a toner to thereby fix the developer on a recording medium.

A fixing apparatus in these days includes a fixing belt for reducing heat capacity (e.g., JP-A-2004-109650). The fixing belt is wound around a fixing roller and a metal roller. A recording medium having a developer transferred thereon is nipped by the fixing roller and a pressing roller that is set in contact with the fixing roller across the fixing belt and includes a heating device. The recording medium is pressed and heated while being conveyed.

In such a fixing apparatus, the position of the fixing belt is regulated by regulating plates set at both ends of the fixing roller. If the fixing belt is pressed by the fixing roller and the pressing roller, it is likely that excessive pressure is applied to both ends of the fixing belt and the fixing belt is broken.

### SUMMARY

It is an object of the present invention to provide a fixing apparatus with improved durable life of a fixing belt and a developer fixing method for the fixing apparatus.

In an aspect of the present invention, a fixing apparatus includes:

a pressing roller having a heating device therein;

a metal roller having a core bar of metal; and

a fixing roller that is set in contact with the pressing roller across a fixing belt wound around the fixing roller and the metal roller, has the width of the center portion formed in a cylindrical shape smaller than the width of the pressing roller, and has, at both ends, small-diameter rollers having a diameter smaller than the diameter of the center portion.

### DESCRIPTION OF THE DRAWINGS

FIG. 1 is a diagram of a configuration example of an image forming apparatus;

FIG. 2 is a side view of a fixing apparatus;

FIG. 3 is a top view of the fixing apparatus;

FIG. 4 is a perspective view of a nip section of a fixing apparatus according to a first embodiment of the present invention;

FIG. 5 is a diagram of a fixing roller having enlarged cutouts in the first embodiment; and

FIG. 6 is a perspective view of a nip section of a fixing apparatus according to a second embodiment of the present invention.

### DETAILED DESCRIPTION

Throughout this description, the embodiments and examples shown should be considered as exemplars, rather than limitations on the apparatus and methods of the present invention.

Fixing apparatuses and developer fixing methods for the fixing apparatuses according to embodiments of the present invention are explained in detail below with reference to the accompanying drawings.

Overview of an Image Forming Apparatus

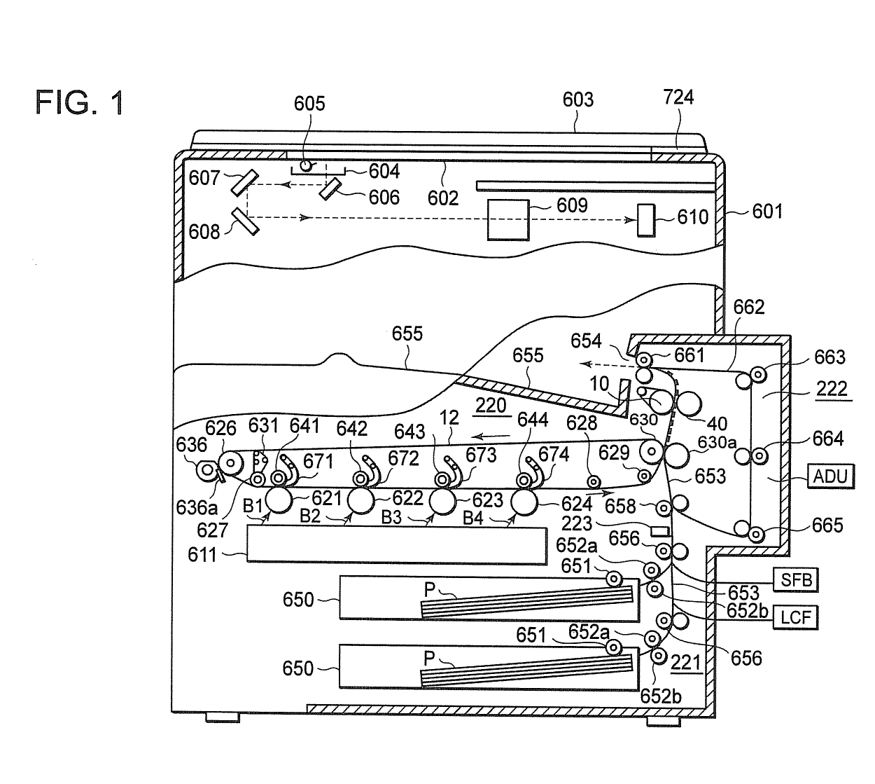

FIG. 1 is a diagram of a configuration example of an image forming apparatus. As shown in FIG. 1, a document table 602, which is made of a transparent material such as a glass plate, for placing an original document is provided in an upper part of an apparatus main body 601. A cover 603 is openably and closably provided in the apparatus main body 601 to cover the document table 602.

On a lower surface side of the document table 602 in the apparatus main body 601, a scan unit (not shown) that optically scans an image of an original document placed on the document table 602 is provided. This scan unit includes, for example, a carriage 604, reflection mirrors 606, 607, and 608 that reflect light of an exposure lamp 605 reflected on the original document, a lens block for magnification 609 for magnifying the reflected light, and a CCD (Charge Coupled Device) 610. The carriage 604 includes the exposure lamp 605 that irradiates light toward the document table 602. The carriage 604 can reciprocatingly move along a lower surface of the document table 602.

The carriage 604 reciprocatingly moves while lighting the exposure lamp 605 to thereby expose the original document placed on the document table 602. A reflected light image of the original document, which is placed on the document table 602, formed by this exposure is projected on the CCD 610 via the reflection mirrors 606, 607, and 608 and the lens block for magnification 609. The CCD 610 outputs image data corresponding to the reflected light image of the original document projected thereon.

An image forming unit 220 is provided below the scan unit in the apparatus main body 601. The image forming unit 220 includes, for example, a print engine (not shown) and a process unit (not shown).

The print engine includes an exposing unit 611. The process unit includes photoconductive drums 621, 622, 623, and 624 arranged along the exposing unit 611, an endless transfer belt 12 arranged to be opposed to the exposing unit 611 across the photoconductive drums 621, 622, 623, and 624, a drive roller 626 that drives the transfer belt 12, primary transfer rollers 641, 642, 643, and 644 arranged to be opposed to the photoconductive drums 621, 622, 623, and 624 across the transfer belt 12, and a transfer-roller driving unit that drives the primary transfer rollers 641, 642, 643, and 644.

The transfer belt 12 is laid over the drive roller 626, guide rollers 627, 628, and 629, and a driven roller 630 and receives the power from the drive roller 626 to rotationally travel in the counter clockwise direction. The guide roller 627 is provided to freely move up and down and receives the pivotal movement of a cam 631 to move to the transfer belt 12 side. Consequently, the guide roller 627 displaces the transfer belt 12 to the photoconductive drums 621, 622, 623, and 624 side.

The image forming unit 220 executes an image forming process for forming an image based on image data (an image signal outputted from the CCD 610) and printing the image on a recording medium being conveyed. The image signal outputted from the CCD 610 is supplied to the exposing unit 611 after being appropriately processed. The exposing unit 611 emits a laser beam B1 corresponding to an image signal of a yellow color, a laser beam B2 corresponding to an image signal of a magenta color, a laser beam B3 corresponding to an image signal of a cyan color, and a laser beam B4 corresponding to an image signal of a black color to the photoconductive drum 621 for the yellow color, the photoconductive drum 622 for the magenta color, the photoconductive drum 623 for the cyan color, and the photoconductive drum 624 for the black color, respectively.

The primary transfer rollers 641, 642, 643, and 644 are respectively moved (lowered) to the transfer belt 12 side to thereby bring the transfer belt 12 into contact with the photoconductive drums 621, 622, 623, and 624 and transfer visible images on the photoconductive drums 621, 622, 623, and 624 onto the transfer belt 12.

A drum cleaner, a charge removing lamp, a charging unit, and a developing unit not shown in the figure are arranged around the photoconductive drum 621 in order. The drum cleaner has a drum cleaning blade that is set in contact with the surface of the photoconductive drum 621. The drum cleaner scrapes off a developer remaining on the surface of the photoconductive drum 621 with the drum cleaning blade.

The charge removing lamp removes charges remaining on the surface of the photoconductive drum 621. The charging unit applies high voltage to the photoconductive drum 621 to thereby charge the surface of the photoconductive drum 621 with electrostatic charges. The laser beam B1 emitted from the exposing unit 611 is irradiated on the surface of the charged photoconductive drum 621. An electrostatic latent image is formed on the surface of the photoconductive drum 621 by the irradiation of the laser beam B1. The developing unit supplies a developer (a toner) of the yellow color onto the surface of the photoconductive drum 621 to thereby visualize the electrostatic latent image on the surface of the photoconductive drum 621.

The other photoconductive drums 622, 623, and 624 visualize electrostatic latent images on the surfaces of the photoconductive drums 622, 623, and 624 using the developers of the colors corresponding thereto, respectively, in the same manner.

A cleaner 636 is provided, across the transfer belt 12, in a position of the image forming unit 220 opposed to the drive roller 626. The cleaner 636 has a cleaning blade 673a that is set in contact with the transfer belt 12. The cleaner 636 scrapes off a developer remaining on the transfer belt 12 with the cleaning blade 673a.

Printing modes are changed as explained below. Hooks 671, 672, 673, and 674 are provided near the primary transfer rollers 641, 642, 643, and 644, respectively. The hooks 671, 672, 673, and 674 respectively engage with shafts of the primary transfer rollers 641, 642, 643, and 644 while pivoting to lift the shafts and move the primary transfer rollers 641, 642, 643, and 644 in a direction away from the photoconductive drums 621, 622, 623, and 624. Printing modes such as a full-color mode, a complete separation mode, and a monochrome mode are changed by not moving all of the primary transfer rollers 641, 642, 643, and 644 or changing a combination of the primary transfer rollers to be moved.

Storing mechanisms and feeding mechanisms for recording media are explained below. Plural recording media cassettes 650 for storing recording media are provided below the exposing unit 611. In the recording media cassettes 650, a large number of recording media P of types different from one another are stored in a stacked state. Recording-media feeding mechanisms 221 for feeding the recording media in the recording media cassettes 650 one by one from the top are respectively provided in outlet portions (on the right side in the figure) of the recording media cassettes 650. The recording media P are taken out one by one from any one of the recording media cassettes 650 by any one of the recording-media feeding mechanisms 221. The recording-media feeding mechanism 221 for taking out the recording media P includes a pickup roller 651, a recording-media feeding roller 652a, and a separating roller 652b. The recording-media feeding mechanism 221 separates the recording media P, which are taken out from the recording media cassette 650, one by one and feeds the recording media P to a recording-media conveying mechanism 653.

A conveying path for recording media is explained below. The recording-media conveying mechanism 653 extends to a recording-media discharge port 654 in an upper part via the driven roller 630 of the image forming unit 220. The recording-media discharge port 654 faces a recording-media discharging section 655 that continues to an outer peripheral surface of the apparatus main body 601. Conveying rollers 656 are provided near the recording-media feeding mechanisms 221, respectively, on a start end side of the recording-media conveying mechanism 653. When a recording medium is fed by any one of the recording-media feeding mechanisms 221, the recording-media conveying mechanism 653 conveys the fed recording medium to the recording-media discharging section 655.

A secondary transfer roller 630a is provided in a position along the recording-media conveying mechanism 653 opposed to the driven roller 630 across the transfer belt 12. Registration rollers 658 are provided in a position before the driven roller 630 and the secondary transfer roller 630a in a conveying direction.

The registration rollers 658 delivers the recording medium P to between the transfer belt 12 and the secondary transfer roller 630a at timing synchronizing with a transfer operation by the transfer belt 12 and the secondary transfer roller 630a for transferring an image formed by a developer (a toner) onto the recording medium P. The secondary transfer roller 630a transfers, while holding the recording medium P delivered from the registration rollers 658 in conjunction with the transfer belt 12 on the driven roller 630, a visible image, which is formed by the developer (the toner) and transferred onto the transfer belt 12, onto the recording medium P and prints the visible image. In this way, the registration rollers 658 convey, in synchronization with a transfer operation of the image forming unit 220, the recording medium P to the image forming unit 220 including the transfer belt 12 and the secondary transfer roller 630a.

A fixing apparatus to fix thermally is provided in a position further on a downstream side than the secondary transfer roller 630a of the recording-media conveying mechanism 653. The fixing apparatus includes a metal roller, a fixing roller 10, a fixing belt wound around the metal roller and the fixing roller 10, an a pressing roller 40 that is set in contact with the fixing roller 10 across the fixing belt. The pressing roller 40 includes a heating device such as a heater lamp.

The recording medium P having the developer transferred thereon is nipped by the fixing roller 10 and the pressing roller 40 and heated and pressed while being carried. When the recording medium P is heated and pressed, the developer is fixed on the recording medium P. A recording-media discharging roller 661 is provided at a terminal end of the recording-media conveying mechanism 653.

An automatic duplex unit (hereinafter referred to as ADU) 222 may be provided in the apparatus main body 601. The ADU 222 is set to couple a sub-conveying path 662, which is a path for conveying the recording medium P in the ADU 222, to the terminal end of the recording-media conveying mechanism 653 and an inlet of the registration rollers 658. The sub-conveying path 662 branches from a downstream side of the recording-medium conveying mechanism 653 with respect to the image forming unit 220 (the terminal end of the recording-media conveying mechanisms 653) and merges into an upstream side of the recording-media conveying mechanism 653 with respect to the image forming unit 220 (an upstream side position of the registration rollers 658).

The sub-conveying path 662 reverses the front and the back of the recording medium P to perform duplex printing. Recording media feeding rollers 663, 664, and 665 are provided in the sub-conveying path 662. The ADU 222 reverses the recording medium P conveyed from the image forming unit 220 to the recording-media discharging section 655, conveys the recording medium P through the sub-conveying path 662, and merges the recording medium P into the recording-media conveying mechanism 653 on the upstream side of the image forming unit 220. If the recording medium P is conveyed in this way, the front and the back of the recording medium P is reversed.

The recording medium P returned to the upstream side of the image forming unit 220 by the sub-conveying path 662 merges into the recording-media conveying mechanism 653. Thereafter, while being synchronized with a transfer operation of the image forming unit 220, the recording medium P is delivered by the registration rollers 658 to a transfer position where the transfer belt 12 and the secondary transfer roller 630a are in contact with each other. In this way, the visible image on the transfer belt 12 is transferred onto the back of the recording medium P and printed as well.

If the duplex printing is designated from an operation panel 724 provided in the apparatus main body 601, a computer connected to the apparatus main body 601 through a network, or the like, the sub-conveying path 662 of the ADU 222 is brought into a state for performing an action for reversing the front and the back of the recording medium P.

Devices additionally provided in the apparatus main body 601 are explained below. In the example of the apparatus main body 601 shown in FIG. 1, a pair of the recording media cassettes 650 are provided as feeding sources of recording media. However, a trio or more of the recording media cassettes 650 may be provided in the apparatus main body 601. Besides, although not shown in the figure, it is also possible to provide a manual-feed recording-media feeding mechanism (hereinafter referred to as SFB) and a large-capacity recording media feeder (hereinafter referred to as LCF), which is a recording-media feeding mechanism that can store several thousands recording media in a stack state. The SFB and the LCF are set in the apparatus main body 601 such that a path for feeding the recording media merges into the recording-media conveying mechanism 653.

A recording-media type sensor 223 may be provided in the apparatus main body 601. The recording-media type sensor 223 is arranged in a position on the upstream side of the recording-media conveying mechanism 653 with respect to the image forming unit 220 and further on the upstream side than the registration rollers 658. The recording-media type sensor 223 detects a type of the recording medium P conveyed by the recording-media conveying mechanism 653. As the recording-media type sensor 223, it is possible to use, for example, a publicly-known sensor that determines a type of the recording medium P by detecting the thickness and the light transmittance of the recording medium P.

If the SFB and the LCF are set, the recording-media type sensor 223 is arranged further on the downstream side than a merging point of a recording-media feeding path from the SFB and the LCF and the recording-media conveying mechanism 653. By arranging the recording-media type sensor 223 in this way, it is possible to detect, with one recording-media type sensor 223, types of the recording media P conveyed on the recording-media conveying mechanism 653 from all the recording-media feeding sources.

Fixing Apparatus

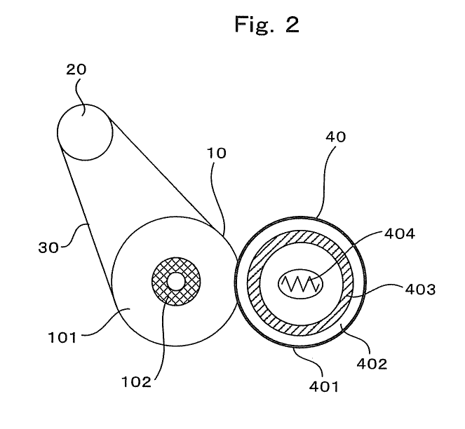

FIG. 2 is a side view of the fixing apparatus. As shown in the figure, the fixing apparatus includes a metal roller 20, the fixing roller 10, and a fixing belt 30 wound around the metal roller 20 and the fixing roller 10.

The fixing belt 30 includes electrocast nickel, stainless steel, or polyimide as a base material and has a heat-resistant elastic layer of silicon rubber on an outer circumferential surface thereof. An annular belt is used as the fixing belt 30. Moreover, a belt obtained by coating an outer layer of silicon rubber with highly-releasable fluorine resin such as PFA (tetrafluoroethylene perfluoroalkyl vinyl ether copolymer) may be used.

As the metal roller 20, a roller obtained by coating a hollow core bar of aluminum or iron with PFA can be used.

As the fixing roller 10, a roller obtained by providing a heat-resistant elastic layer 101 of silicon sponge or the like in a hollow core bar 102 of aluminum or iron can be used. It is desirable to use a heat-resistant elastic layer having low hardness as the heat-resistant elastic layer 101 in order to secure a wide nip.

Moreover, the fixing apparatus includes the pressing roller 40 that is set in contact with the fixing roller 10 across the fixing belt 30.

As the pressing roller 40, it is possible to use a roller obtained by providing a heat-resistant elastic layer 402 such as silicon sponge on a hollow core bar 403 of aluminum or iron and forming a coated layer 401 on an outer circumference of the heat-resistant elastic layer 402 with PFA. A halogen heater 404 may be used as a heat source on an inner side of the pressing roller 40.

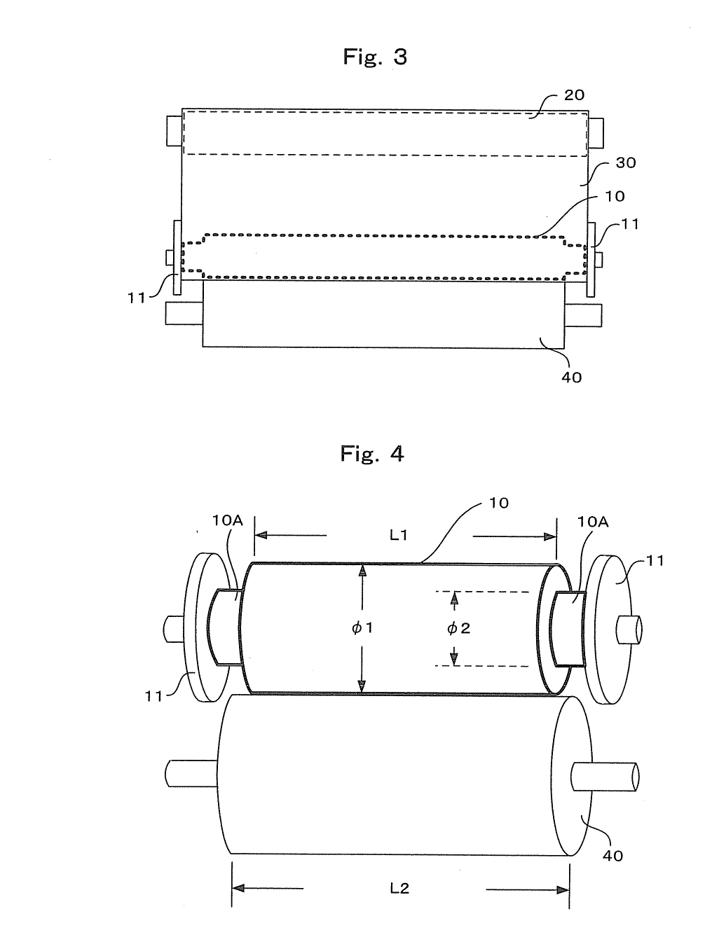

FIG. 3 is a top view of the fixing apparatus. As shown in FIG. 3, the fixing roller 10 includes, at both ends thereof, regulating plates 11 that regulate a position of the fixing belt. The diameter of the regulating plates 11 is larger than the diameter of the fixing roller 10.

The recording medium P is nipped between the fixing roller 10 and the pressing roller 40 together with the fixing belt 30 and heated and pressed while being conveyed.

### First Embodiment

FIG. 4 is a perspective view of a nip section of a fixing apparatus according to a first embodiment of the present invention. In FIG. 4, the fixing belt 30 is not shown. As shown in FIG. 4, in the fixing apparatus, the fixing roller 10 has cutouts at both ends thereof.

The width L1 of the center portion formed in a cylindrical shape of the fixing roller 10 is smaller than the width L2 of the pressing roller 40. The fixing roller 10 includes small-diameter rollers 10A at both ends thereof. The diameter φ2 of the small-diameter rollers 10A is smaller than the diameter φ1 of the center portion of the fixing roller 10.

It is desirable that a half of a difference between φ1 and φ2 is larger than the thickness of the fixing belt 30. If the half of the difference is smaller than the thickness of the fixing belt 30, since excessive pressure is applied to both the ends of the fixing belt 30, the fixing belt 30 is easily broken.

It is desirable that φ2 is larger than φ1/2. If φ2 is smaller than φ1/2, the small-diameter rollers 10A cannot support the regulating plates 11.

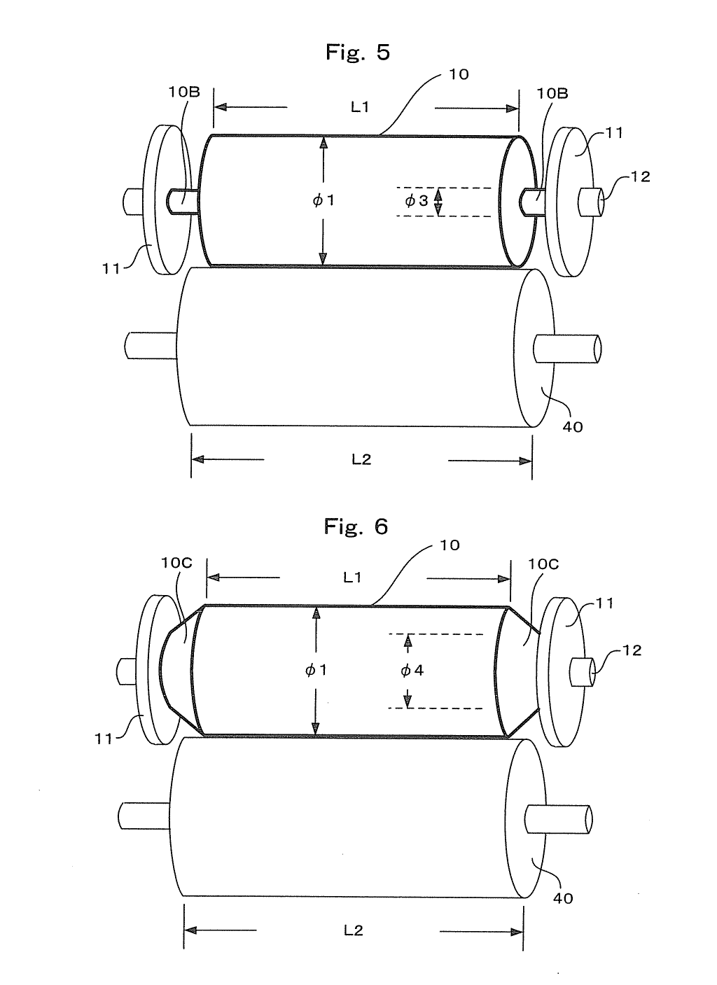

FIG. 5 is a diagram of the fixing roller 10 having enlarged cutouts in the first embodiment. In FIG. 5, the fixing belt 30 is not shown. As shown in FIG. 5, if the regulating plates 11 are firmly fixed to a shaft 12, the diameter φ3 of small-diameter rollers 10B can be set the same as the diameter of the shaft 12.

The fixing belt 30 is bent to the small-diameter rollers 10A or 10B side in the nip section between the fixing roller 10 and the pressing roller 40. Therefore, excess pressure is not applied to both the ends of the fixing belt 30.

As explained above, the fixing apparatus according to this embodiment has the fixing roller 10 with both the ends cut out. Therefore, there is an effect that excessive pressure is not applied to both the ends of the fixing belt 30 and it is possible to extend the durable life of the fixing belt 30.

### Second Embodiment

FIG. 6 is a perspective view of a nip section of a fixing apparatus according to a second embodiment of the present invention. In FIG. 6, the fixing belt 30 is not shown. As shown in FIG. 6, in the fixing apparatus, the fixing roller 10 has tapered portions 10C at both the ends thereof.

In the fixing roller 10, the width L1 of the center portion formed in a cylindrical shape is smaller than the width L2 of the pressing roller 40. The diameter φ4 of the distal ends of the tapered portions 10C is smaller than the diameter φ1 of the center portion of the fixing roller 10.

It is desirable that a half of a difference between φ1 and φ4 is larger than the thickness of the fixing belt 30. If the half of the difference is smaller than the thickness of the fixing belt 30, since excessive pressure is applied to both the ends of the fixing belt 30, the fixing belt 30 is easily broken.

It is desirable that φ4 is larger than φ1/2. If φ4 is smaller than φ1/2, the tapered portion 10C cannot support the regulating plates 11.

If the regulating plates 11 are firmly fixed to the shaft 12, the diameter φ4 of the distal ends of the tapered portions 10C can be set the same as the diameter of the shaft 12.

The fixing belt 30 is bent to the tapered portions 10C side in the nip section between the fixing roller 10 and the pressing roller 40. Therefore, excessive pressure is not applied to both the ends of the fixing belt 30. Since the pressure applied to the fixing roller 10 is dispersed to the tapered portions 10C, there is an effect that it is possible to use a thinner core bar and reduce the weight of an image forming apparatus.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A fixing apparatus comprising:
a pressing roller having a heating device therein;
a metal roller having a core bar of metal; and
a fixing roller that is set in contact with the pressing roller across a fixing belt wound around the fixing roller and the metal roller, has width of a center portion formed in a cylindrical shape smaller than width of the pressing roller, and has, at both ends, small-diameter rollers having a diameter smaller than a diameter of the center portion.

2. The apparatus according to claim 1, wherein
the fixing roller and the pressing roller press, via the fixing belt, a recording medium having a developer transferred thereon, and
the pressing roller heats the developer to thereby fix the developer on the recording medium.

3. The apparatus according to claim 1, wherein a half of a difference between the diameter of the center portion of the fixing roller and the diameter of the small-diameter rollers is larger than thickness of the fixing belt.

4. The apparatus according to claim 1, wherein the fixing roller has, at both the ends, regulating plates that regulate a position of the fixing belt.

5. The apparatus according to claim 1, wherein the diameter of the small-diameter rollers is larger than a half of the diameter of the fixing roller.

6. The apparatus according to claim 1, wherein the diameter of the small-diameter rollers is equal to a diameter of a shaft of the fixing roller.

7. The apparatus according to claim 1, wherein an outer circumference of the fixing roller is coated with fluorine resin.

8. A fixing apparatus comprising:
a pressing roller having a heating device therein;
a metal roller having a core bar of metal; and
a fixing roller that is set in contact with the pressing roller across a fixing belt wound around the fixing roller and the metal roller, has width of a center portion formed in a cylindrical shape smaller than width of the pressing roller, and has, at both ends, tapered portions having a diameter of distal ends smaller than a diameter of the center portion.

9. The apparatus according to claim 8, wherein
the fixing roller and the pressing roller press, via the fixing belt, a recording medium having a developer transferred thereon, and
the pressing roller heats the developer to thereby fix the developer on the recording medium.

10. The apparatus according to claim 8, wherein a half of a difference between the diameter of the center portion of the fixing roller and the diameter of the distal ends of the tapered portions is larger than thickness of the fixing belt.

11. The apparatus according to claim 8, wherein the fixing roller has, at both the ends, regulating plates that regulate a position of the fixing belt.

12. The apparatus according to claim 8, wherein the diameter of the distal ends of the tapered portions is larger than a half of the diameter of the fixing roller.

13. The apparatus according to claim 8, wherein the diameter of the distal ends of the tapered portions is equal to a diameter of a shaft of the fixing roller.

14. The apparatus according to claim 8, wherein an outer circumference of the fixing roller is coated with fluorine resin.

15. A developer fixing method for a fixing apparatus comprising a pressing roller having a heating device therein pressing, while heating a developer transferred on a recording medium, the recording medium having the developer transferred thereon to fix the developer in conjunction with a fixing roller that is set in contact with the pressing roller across a fixing belt wound around the fixing roller and a metal roller having a core bar of metal, has width of a center portion formed in a cylindrical shape smaller than width of the pressing roller, and has, at both ends, small-diameter rollers having a diameter smaller than a diameter of the center portion.

16. The method according to claim 15, wherein a half of a difference between the diameter of the center portion of the fixing roller and the diameter of the small-diameter rollers is larger than thickness of the fixing belt.

17. The method according to claim 15, wherein
the fixing roller has, at both the ends, regulating plates, and
the regulating plates regulate a position of the fixing belt.

18. A developer fixing method for a fixing apparatus comprising a pressing roller having a heating device therein pressing, while heating a developer transferred on a recording medium, the recording medium having the developer transferred thereon to fix the developer in conjunction with a fixing roller that is set in contact with the pressing roller across a fixing belt wound around the fixing roller and a metal roller having a core bar of metal, has width of a center portion formed in a cylindrical shape smaller than width of the pressing roller, and has, at both ends, tapered portions having a diameter of distal ends smaller than a diameter of the center portion.

19. The method according to claim 18, wherein a half of a difference between the diameter of the center portion of the fixing roller and the diameter of the small-diameter rollers is larger than thickness of the fixing belt.

20. The method according to claim 18, wherein
the fixing roller has, at both the ends, regulating plates, and
the regulating plates regulate a position of the fixing belt.
